(19) United States
(12) Patent Application Publication
(10) Pub. No.: US 2013/0255296 A1
(43) Pub. Date: Oct. 3, 2013

(54) RADIATOR ARRANGEMENT IN A VEHICLE POWERED BY A COMBUSTION ENGINE

(71) Applicants: Zoltan Kardos, Sodertalje (SE); Ola Hall, Stockholm (SE)

(72) Inventors: Zoltan Kardos, Sodertalje (SE); Ola Hall, Stockholm (SE)

(21) Appl. No.: 13/991,446

(22) PCT Filed: Nov. 24, 2011
(86) PCT No.: PCT/SE2011/051418

§ 371 Date: Jun. 4, 2013

(30) Foreign Application Priority Data
Dec. 14, 2010 (SE) 1051316-6

(51) Int. Cl. B60H 1/32

(52) U.S. Cl. CPC B60H 1/3205
USPC 62/126

(57) ABSTRACT

A radiator arrangement in a vehicle (1) powered by a combustion engine (2). The arrangement includes an AC system (20) with a circulating refrigerant which gives off heat in a condenser (12) and absorbs heat in an evaporator (23) and the evaporator is in contact with air close to a cab space (24) in the vehicle (1). A line circuit in which circulating coolant comes into heat-transferring contact with the engine (2). The condenser (12) is in heat-transferring contact with coolant which circulates through the line circuit. An activator for the AC system (20) causes coolant to be circulated through the line circuit when the engine (2) is not in operation. When the engine (2) is cold, coolant in the line circuit delivers thermal energy it acquires in the condenser (12).

### BACKGROUND TO THE INVENTION AND PRIOR ART

The present invention relates to a radiator arrangement in a vehicle powered by a combustion engine according to the preamble of claim 1.

An AC system is commonly used to cool the cab space in a vehicle. AC systems comprise a cooling circuit with a circulating refrigerant. The circulating refrigerant cools the air in the cab space when it vaporises in an evaporator and gives off heat to surrounding air when it condenses in a condenser. The condenser is usually situated at the front portion of the vehicle near to the radiator in which the coolant in the engine's cooling system is cooled. During operation, air is drawn through the condenser and the radiator by a radiator fan driven by the engine. The engine also drives a compressor which compresses and circulates the refrigerant in the AC system.

It is often desired to use the AC system in the vehicle even at times when the engine is not running. A known practice in this respect is to run the compressor on electrical energy and use an electrically operated fan to force a cooling air flow through the condenser. When the AC system is used at such times, electrical energy is supplied to its compressor and the electric fan from the vehicle's battery. To avoid reducing the capacity of the battery to too low a level, the AC system is run in such circumstances at a significantly lower capacity than when it is powered by the engine. For the AC system to be able to provide acceptable cooling of the air in the cab space, it is important that the refrigerant undergoes effective cooling in the condenser. To achieve this, the electrically operated fan has to force a relatively large amount of air through the condenser. The fan's consumption of electrical energy will thus be relatively high.

### SUMMARY OF THE INVENTION

The object of the present invention is to propose a radiator arrangement in a vehicle whereby an AC system can be run in an energy-economising way even at times when the vehicle's engine is not running.

This object is achieved with the radiator arrangement of the kind mentioned in the introduction which is characterised by the features indicated in the characterising part of claim 1. Within a few hours after it has been switched off, a combustion engine usually cools to a temperature close to that of the surroundings. The engine usually comprises an engine block made of metal material with a large mass. When the temperature of the surroundings varies, such a large mass takes a certain time to reach their temperature. When for example the temperature of the surroundings rises after a cold night, the engine may be at a definitely lower temperature than that of the surrounding air. The radiator arrangement therefore comprises a line circuit with a circulating coolant which is in heat-transferring contact with both the engine and the AC system's condenser. The coolant which circulates in the line circuit undergoes good cooling when it comes into contact with the cold engine. The cooled coolant is then used to cool the refrigerant in the condenser. The refrigerant thus undergoes good cooling in the condenser, causing it to have a low vaporisation temperature in the evaporator. The low vaporisation temperature of the refrigerant provides assurance of good cooling of the air in the cab space. As the engine is of large mass, the coolant which circulates in the line circuit can deliver relatively large amounts of thermal energy to the engine without appreciably raising the engine's temperature. The engine may therefore have the advantage of receiving a relatively large amount of thermal energy from the AC system. The radiator arrangement is activated with advantage on warm days when the driver is in the vehicle's cab space but the engine is not running. The cold engine serves in this case as a very good cold source for the AC system. The AC system can thus provide good cooling of the air in the cab space relative to the amount of energy supplied to circulate the coolant in the line circuit and compress the refrigerant in the AC system.

According to a preferred embodiment of the invention, said activation means comprises a manual activation device by which the radiator arrangement can be activated at times when the engine is not running, and a control unit adapted to receiving information from the activation device and to activating a compressor in the AC system and a coolant pump in the line circuit when the activation device is put into an active state. When a person who is in the vehicle's cab space feels too warm, he/she will put the activation device into the active state. The activation device may be a button or the like which is pressed in or moved to an active position. When this is done, the control unit starts both the AC system and the circulation of coolant through the line circuit.

According to another preferred embodiment of the invention, the control unit is adapted to receiving information from a sensor which monitors a parameter related to the temperature of the engine, and to only circulating coolant through the line circuit if it receives information that the engine is at a lower temperature than a reference value. The reference value may be a predetermined temperature or a temperature which is related to that of the surrounding air. When the engine is used as cold source, it continuously receives thermal energy from the coolant circulating in the line circuit. The engine thus acquires a progressively rising temperature. When its temperature exceeds the reference value, the engine is no longer viable as a cold source. The control unit is with advantage adapted to circulating the coolant through an alternative line circuit in which the circulating coolant comes into heat-transferring contact with the condenser but not with the engine at times when the control unit receives information that the engine is at a higher temperature than the reference value. In the alternative line circuit some other cold source is used to cool the circulating coolant.

According to another preferred embodiment of the invention, the radiator arrangement comprises valve means which can be put into a first state in which they led the coolant through said line circuit, and a second state in which they lead the coolant through the alternative line circuit. Suitably located valve means may be used to divert the coolant relatively easily from circulation in the line circuit to circulation in the alternative line circuit. Such switching of the valve means takes place with advantage at times when the engine is at a temperature above the reference value. The alternative line circuit may comprise an air-cooled radiator for cooling the coolant, and the radiator arrangement comprises an electrically operated fan to force a cooling air flow through the radiator at times when the engine is at a temperature above said reference value. The electrically operated compressor may be an extra compressor situated in parallel with an ordinary compressor. Alternatively, the AC system may comprise an ordinary compressor which can also be run on electrical energy, in which case the electrically operated fan with advantage forces air at the temperature of the surroundings through the condenser. This results in good cooling of the refrigerant of the condenser but entails supply of electrical energy to run the fan.

According to another preferred embodiment of the invention, said line circuit comprises at least part of a first cooling system with a circulating coolant intended to cool the engine during operation, and at least part of a second cooling system with a circulating coolant which during normal operation of the engine is at a lower temperature than the coolant in the first cooling system. When a vehicle is equipped with two such cooling systems it is very appropriate to use suitable parts of the existing cooling systems for said line circuit and the alternative line circuit. The condenser is with advantage in heat-transferring contact with the coolant in a region of said line circuit which forms part of the second cooling system. This means that the cold coolant in the second cooling system can also be used to cool the refrigerant in the condenser during operation of the engine.

According to another preferred embodiment of the invention, said line circuit comprises at least one line for transfer of coolant between the first cooling system and the second cooling system. If the engine is in the first cooling system and the condenser is in the second cooling system, said line circuit needs to have lines which in some way transfer coolant between the existing cooling systems. The alternative line circuit corresponds with advantage to the second cooling system. The existing coolant pump in the second cooling system may with advantage be used to circulate the coolant through both the line circuit and the alternative line circuit. The coolant led through the alternative line circuit is cooled with advantage by a cooling air flow forced through the radiator by an electrically operated air fan.

### BRIEF DESCRIPTION OF THE DRAWING

A preferred embodiment of the invention is described below by way of example with reference to the attached drawing, in which

FIG. 1 depicts a radiator arrangement in a vehicle powered by a combustion engine according to a preferred embodiment of the invention.

### DETAILED DESCRIPTION OF A PREFERRED EMBODIMENT OF THE INVENTION

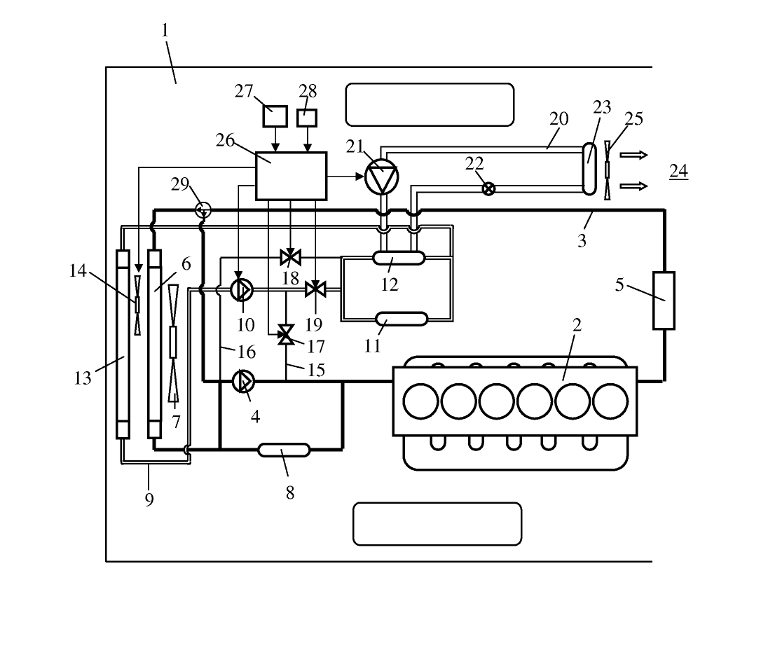

FIG. 1 depicts schematically a vehicle 1 powered by a combustion engine 2. The engine 2 may be a diesel engine and the vehicle 1 a heavy vehicle. During operation, the engine 2 is cooled by a first cooling system 3. The first cooling system 3 is hereinafter called the engine's cooling system. A first coolant pump 4 circulates the coolant through the engine's cooling system. The first coolant pump 4 may be driven by the engine 2. The first coolant pump 4 circulates the coolant initially through the engine 2. The coolant leaving the engine 2 is led in this case to an oil cooler 5 in which it cools oil which is used in a retarder. When the coolant has cooled the oil in the oil cooler 5, it is led to a thermostat 29. If the coolant is below an intended operating temperature, the thermostat 29 directs it to the coolant pump 4. When the coolant is above the intended operating temperature, it is led to an air-cooled first radiator 6 fitted at a forward portion of the vehicle 1. The coolant is here cooled by air drawn through the first radiator 6 by a radiator fan 7. The radiator fan 7 may in a conventional way be driven by the engine 2. When the coolant has been cooled in the first radiator 6, it is led back to the coolant pump 4 and the engine 2. However, part of the cooled coolant from the first radiator 6 is led in a parallel line to an EGR cooler 8 for cooling of recirculating exhaust gases. The coolant from the EGR cooler 8 is mixed with coolant from the first coolant pump 4 and is led to the engine 2. Coolant in the engine's cooling system is at a temperature of the order of 80-100° C. during normal operation.

The vehicle 1 is provided with a second cooling system 9 which may be described as a low-temperature cooling system. A second coolant pump 10 circulates the coolant through the second cooling system. The coolant from the second coolant pump 10 is led initially through two parallel lines. One parallel line comprises a charge air cooler 11 and the other parallel line a condenser 12. The coolant cools charge air in the charge air cooler 11 and a refrigerant in the condenser 12. The coolant is then led through a common line to a second radiator 13 fitted at the forward portion of the vehicle 1. The coolant is here cooled by air drawn through the second radiator 13 by the radiator fan 7. Alternatively, an electrically operated fan 14 may be used to draw air through the second radiator 13. The coolant which has been cooled in the second radiator 13 is then led back to the second coolant pump 10. The second radiator 13 is fitted in front of the first radiator 6. The coolant in the second cooling system 9 will thus be cooled by air at the temperature of the surroundings, whereas the coolant in the engine's cooling system 3 will be cooled by air at a higher temperature. The coolant in the second cooling system 9 may therefore be at a significantly lower temperature than the coolant in the engine's cooling system 3. In the second radiator 13 the coolant may in favourable circumstances be cooled to a temperature close to the temperature of the surroundings.

The engine's cooling system 3 may be connected to the second cooling system 9 by a first line 15 and a second line 16. The first line 15 comprises a first valve 17. The second line 16 comprises a second valve 18. A third valve 19 is provided in the second cooling system 9 at a location substantially immediately downstream of the location where the first line 15 is connected to the second cooling system 9. The vehicle is provided with an AC system 20 comprising not only said condenser 12 but also a compressor 21 adapted to compressing and circulating the refrigerant in the AC system 20. The AC system 20 further comprises an expansion valve 22 adapted to reducing the pressure of the refrigerant, and an evaporator 23 in which the refrigerant is intended to vaporise. The evaporator 23 is situated close to a cab space 24 in the vehicle 1. A fan 25 forces air in the cab space 24 or air which is led into the cab space 24 through the evaporator 23 so that it undergoes cooling. An electrical control unit 26 is adapted to receiving information from a manual activation device 27 which may be a push-button or equivalent which is put into an active state when the AC system 20 is to be activated. The control unit 26 is also adapted to receiving information from a temperature sensor 28 which monitors the temperature of the engine 2. The control unit 26 is adapted to controlling the activation of the second coolant pump 10, the air fan 14 and the compressor 21 and to being able to put the valves 17, 18, 19 into open and closed states.

During operation of the engine 2, the control unit 26 puts the first valve 17 and the second valve 18 into a closed state. This means that no coolant can circulate between the engine's cooling system 3 and the second cooling system 9. At the same time, the control unit 26 puts the third valve 19 into an open state so that cold coolant from the second coolant pump 10 can be led to the charge air cooler 11 and the condenser 12. The engine's cooling system 3 and the second cooling system 9 thus operate as two completely separate cooling systems when the engine 2 is in operation. The coolant in the second cooling system 9 will thus be at a definitely lower temperature than the coolant in the engine's cooling system 3. During operation of the engine 2, the AC system 20 may be activated automatically or by a person in the vehicle putting the manual activation device 27 into the active position. When this takes place, the control unit 26 starts the compressor 21 so that it compresses and circulates the refrigerant in the AC system 20. The circulating refrigerant is cooled in the condenser 12 by the coolant which is circulated in the second cooling system 9 by the second coolant pump. As the coolant in the second cooling system 9 may in favourable circumstances be at a temperature close to the temperature of the surroundings, the refrigerant undergoes very good cooling in the condenser 12. When the refrigerant has expanded through the expansion valve 22, it will be at a low pressure and a low temperature. The cold refrigerant is led to the evaporator 23, in which it is warmed by the air in the cab space 24 to a temperature at which it vaporises. The vaporised refrigerant is then led back to the compressor 21 from the evaporator 23. The compressor 21 compresses the refrigerant so that it reverts to a high pressure and a high temperature.

When the engine 2 is in operation, it drives the compressor 21. The engine is also used with advantage to drive the radiator fan 7 so that it forces a cooling air flow through the first radiator 6 and the second radiator 13. The coolant in the second cooling system 9 therefore undergoes very good cooling in the second radiator 13. The cold coolant in the second cooling system 9 is then used to cool the refrigerant in the condenser 12. The refrigerant thus assumes a relatively low condensation temperature in the condenser 12. A low condensation temperature in the condenser 12 makes it possible for the refrigerant to have a low vaporisation temperature in the evaporator 23. The air in the cab space 24 may thus undergo very good cooling in the evaporator by the cold refrigerant.

At times when the engine 2 is not in operation, the AC system may be activated by using the manual activation device 27. When it receives information that the manual activation device 27 has been put into an active state, the control unit 26 will find that the AC system 20 is to be activated. It then connects the vehicle's battery in an appropriate way to the compressor 21. Alternatively, the AC system 20 may comprise two compressors, viz. an ordinary compressor driven by the engine 2 and an electrically powered extra compressor 21 run on stored electrical energy from the vehicle's battery. At the same time, the control unit 26 will start the second coolant pump 10 and hence the circulation of coolant which cools refrigerant in the condenser 12. The present invention primarily uses the engine 2 as cold source for cooling the circulating coolant. A combustion engine 2 in a heavy vehicle may weigh nearly 800 kg. Such a large mass may store relatively large amounts of thermal energy. For the engine 2 to be used as cold source, however, it needs to be cold. It is therefore not usable as cold source until it has cooled to a temperature substantially corresponding to that of the surroundings. This may only be when the engine has not been in operation for a certain time. The control unit 26 receives information from the temperature sensor 28 for deciding whether the engine 2 has become cool enough to be usable as cold source. The control unit 26 may here compare the temperature of the engine 2 with a reference value T_{ref} which may be related to the temperature of the surroundings.

If it receives information from the temperature sensor 28 that the engine 2 is at a lower temperature than the reference value T_{ref}, the control unit 26 puts the first valve 17 and the second valve 18 into open states. The third valve 19 is put into a closed state. This means that the coolant leaving the second coolant pump 10 will initially be led through the first line 15 because of the first valve 17 being open while the third valve 19 is closed. The coolant is thus transferred from the second cooling system 9 to the engine's cooling system 3 via the first line 15. It is then led through the engine 2. The coolant is here cooled in a very effective way by the engine block. In this case the coolant is led through corresponding coolant ducts used for cooling the engine 2 during operation. The cold coolant leaving the engine 2 is led via the oil cooler 5 to the first radiator 6. Since the radiator fan 7 is not in operation when the engine 2 is not running, the coolant undergoes substantially no cooling in the first radiator 6. The coolant leaving the first radiator 6 is therefore gradually led back to the second cooling system 9 via the second line 16. This is possible because of the first coolant pump 4 not being in operation while at the same time the second valve 18 in the second line 16 is open. The cold coolant then passes through the condenser 12, in which it cools the refrigerant in the AC system 20. When the coolant cools the refrigerant in the condenser 12, it undergoes warming. The relatively warm coolant then proceeds to the first radiator 13. As the radiator fan 7 is not in operation, the coolant undergoes only slight cooling in the second radiator 13. It is then led back to the second coolant pump 10 before being led through the engine 2 again.

The coolant is circulated in this case through a line circuit which comprises substantially the whole of the engine's cooling system 3 and the whole of the second cooling system 9. The coolant is here led alternately through the respective cooling systems 3, 9. It thus comes into heat-transferring contact with the engine 2 in the engine's cooling system 3 and with the condenser 12 in the second cooling system 9. The coolant here gives off in the engine block thermal energy acquired by it in the condenser 12. The engine 2 thus undergoes a certain warming.

When it receives information from the temperature sensor 28 that the engine 2 is at a higher temperature than the reference value T_{ref}, the control unit 26 will find that the engine 2 is no longer viable as a cold source. When such is the case, the control unit 26 starts the electrically operated air fan 14, resulting in a cooling air flow through the second radiator 13. At the same time, the control unit 26 puts the first valve 17 and the second valve 18 into closed states. It also ensures that the third valve 19 is put into an open position. The fact that the first valve 17 and the second valve 18 are closed breaks the circulation of coolant between the engine's cooling system 3 and the second cooling system 9. The coolant is thus circulated in an alternative line circuit. The alternative line circuit corresponds in this case to the whole of the second cooling system 9. The coolant is thus led from the second coolant pump 10 to the condenser, in which it cools the refrigerant in the AC system 20. The coolant is then led to the second radiator 13, in which it is cooled by surrounding air which the air fan 14 draws through the second radiator 13. The coolant undergoes cooling in the second radiator 13 before being led back to the second coolant pump 10. The coolant circulated in the alternative line circuit absorbs thermal energy in the condenser 12 and gives off thermal energy to the air forced through the second radiator 13.

The invention is in no way restricted to the embodiment to which the drawing refers but may be varied freely within the scopes of the claims.

1. A radiator arrangement in a vehicle powered by a combustion engine, the arrangement comprising:
an AC system having a refrigerant circuit for circulating a refrigerant which gives off or absorbs heat;
a condenser through which refrigerant is circulated and gives off heat;
an evaporator through which refrigerant is circulated and absorbs heat, the evaporator is in contact with air close to a cab space in the vehicle;
a compressor comprises refrigerant in the AC system;
a line circuit for circulating coolant;
a coolant circulating pump in the line circuit;
the line circuit being configured for bringing the coolant into heat-transferring contact with the engine;
the condenser of the AC system is also in heat-transferring contact with coolant which circulates through the line circuit;
the radiator arrangement comprises an activation unit which activates the AC system for causing the pump to circulate coolant through the line circuit at times when the engine is not in operation, the activation unit comprises an activation device for activating the radiator arrangement when the engine is not in operation;
a sensor which monitors a parameter related to the temperature of the engine; and
a control unit configured for receiving information from the activation device and for activating the compressor in the AC system, and the activation device also activating the coolant pump in the line circuit when the activation device has been put into an active position and receives information from the sensor which monitors a parameter related to the temperature of the engine, and the activator device causes circulating of coolant through the line circuit only if the engine is at a lower temperature than a reference value (T_{ref}).

2. A radiator arrangement according to claim 1, further comprising an alternate line circuit for circulating the coolant; and
the control unit causes circulating of the coolant through the alternative line circuit when the circulating coolant comes into heat-transferring contact with the condenser but not into heat-transferring contact with the engine at times when the engine is at a higher temperature than the reference value (T_{ref}).

3. A radiator arrangement according to claim 2, further comprising a valve system which can be put into a first state wherein the valve system leads the coolant through the line circuit, or put into a second state wherein the valve system leads the coolant through the alternative line circuit.

4. A radiator arrangement according to claim 3, wherein the alternative line circuit comprises an air-cooled radiator for cooling the coolant, and the radiator arrangement comprises an electrically operated fan configured for forcing air through the radiator when the engine is at a higher temperature than the reference value (T_{ref}).

5. A radiator arrangement according to claim 1, wherein the line circuit comprises at least part of a first cooling system having circulating coolant for cooling the engine during its operation and comprises at least part of a second cooling system having circulating coolant which during normal operation of the engine is at a lower temperature than the coolant in the first cooling system.

6. A radiator arrangement according to claim 5, wherein the condenser is in heat-transferring contact with coolant in a region of the line circuit which forms part of the second cooling system.

7. A radiator arrangement according to claim 6, wherein the line circuit comprises at least one line for transfer of coolant between the first cooling system and the second cooling system.

8. A radiator arrangement according to claim 4, wherein the line circuit comprises at least part of a first cooling system having circulating coolant for cooling the engine during its operation and comprises at least part of a second cooling system having circulating coolant which during normal operation of the engine is at a lower temperature than the coolant in the first cooling system; and
the alternative line circuit corresponds to the second cooling system.
